(19) United States
(12) Patent Application Publication
(10) Pub. No.: US 2025/0096871 A1
(43) Pub. Date: Mar. 20, 2025

(54) Event-Triggered CSI Reporting

(71) Applicant: Nokia Technologies Oy, Espoo (FI)

(72) Inventors: Matha DEGHEL, Massy (FR); Samantha CAPORAL DEL BARRIO, Aalborg (DK)

(21) Appl. No.: 18/806,502

(22) Filed: Aug. 15, 2024

(30) Foreign Application Priority Data
Sep. 18, 2023 (GB) 2314259.9

(51) Int. Cl. H04B 7/06; H04W 24/10

(52) U.S. Cl. CPC H04B 7/0626; H04W 24/10

(57) ABSTRACT

This specification describes a method comprising: receiving, at a user equipment, UE, and from a node of a cellular communications network, configuration information relating to an event-triggered channel state information, CSI, reporting mode. The method further comprises the UE, while operating in the event-triggered CSI reporting mode in accordance with the configuration information, responding to an occurrence of a pre-defined event by providing report information to the cellular communications network, wherein i) the pre-defined event is related to a change in a selection associated with a set of transmission reception points, TRPs, ii) the selection is performed by the UE based on measurements of one or more reference signals, and iii) the report information relates to the change in the selection associated with the set of TRPs.

### RELATED APPLICATION

This application claims priority to, and the benefit of, GB Application No. 2314259.9, filed on Sep. 18, 2023, the contents of which is incorporated herein by reference in its entirety.

### FIELD

This specification relates to an event-triggered CSI reporting mode for a user equipment, UE.

### BACKGROUND

Fifth generation (5G) wireless communications networks are the next generation of mobile communications networks. Standards for 5G communications networks are currently being developed by the 3rd Generation Partnership Project (3GPP). 3GPP standards are structured as Releases, and Releases 15 to 18 relate to 5G (or New Radio, NR).

The channel state information (CSI) and reporting framework was first introduced in Release 15, and Releases 16 to 18 include enhancements of the framework. CSI may consist of one or more of: Channel Quality Indicator (CQI), precoding matrix indicator (PMI), CSI-RS resource indicator (CRI), SS/PBCH Block Resource indicator (SSBRI), layer indicator (LI), rank indicator (RI) and/or L1-RSRP (Layer 1 Received Signal Received Power).

CSI reference signals (CSI-RS) have many functions in NR. For instance, they may be utilised for downlink CSI acquisition, for beam management, and for uplink CSI acquisition in reciprocity-based UL precoding. In some applications CSI-RS are spatially beamformed into different directions.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

In a first aspect, this specification describes a method comprising: receiving, at a user equipment, UE, and from a node of a cellular communications network, configuration information relating to an event-triggered channel state information, CSI, reporting mode. The method further comprises the UE, while operating in the event-triggered CSI reporting mode in accordance with the configuration information, responding to an occurrence of a pre-defined event by providing report information to the cellular communications network, wherein i) the pre-defined event is related to a change in a selection associated with a set of transmission reception points, TRPs, ii) the selection is performed by the UE based on measurements of one or more reference signals, and iii) the report information relates to the change in the selection associated with the set of TRPs.

In some examples, the pre-defined event may comprise a change in a selected set of TRPs. In such examples, the pre-defined event may, for instance, comprise a change in the selected set in which at least a threshold number of TRPs in the selected set have changed.

In some examples, the pre-defined event may comprise a change in the number of TRPs selected by the UE. In such examples, the pre-defined event may, for instance, comprise a change in the number of TRPs selected by the UE that is greater than a threshold number.

In some examples, the pre-defined event may comprise a change in at least one of: a selected non-coherent joint transmission, NCJT, measurement hypothesis; a selected single first-TRP measurement hypothesis; a selected single second-TRP measurement hypothesis; and a single TRP measurement hypothesis selected from a first-TRP measurement hypothesis and a second-TRP measurement hypothesis.

In some examples, the pre-defined event may comprise a change in a selection of at least one CSI reference signal, CSI-RS, resource or at least one CSI-RS resource pair.

In some examples the report information may indicate that the pre-defined event has occurred.

The report information may include channel state information relating to the change in the selection associated with the set of TRPs.

The predefined event may, in some examples, comprise a change in a selection associated with at least one TRP that persists for a pre-determined duration or over a predetermined number of iterations.

While operating in the event-triggered CSI reporting mode, the UE may be configured so as to respond to an occurrence of any of a plurality of pre-defined events relating to a change in a selection associated with a set of TRPs by providing report information to the cellular communications network.

In some examples, the method may comprise, while operating in the event-triggered CSI reporting mode in accordance with the configuration information, responding, by the UE, to a determination that the pre-defined event has not occurred by providing to the cellular communications network information indicative of the pre-defined event not having occurred. In such examples, the method may comprise responding, by the UE, to a determination that the pre-defined event has not occurred for a predetermined duration by providing the information indicative of the pre-defined event not having occurred to the cellular communications network.

In some examples, the predefined event may be indicated in the configuration information, and/or one or more parameters associated with the predefined event may be indicated in the configuration information.

In some examples, the method may comprise, prior to receiving the configuration information, the UE informing the cellular communications network that the pre-defined event is supported by the UE.

In some examples, the selection associated with the set of TRPs may be performed by the UE based on measurements of one or more reference signals and based on one or more threshold values configured by the cellular communications network.

In a second aspect, this specification describes a user equipment, UE, (or terminal device) comprising: means for receiving, from a node of a cellular communications network, configuration information relating to an event-triggered channel state information, CSI, reporting mode; and means for, while operating in the event-triggered CSI reporting mode in accordance with the configuration information, responding to an occurrence of a pre-defined event by providing report information to the cellular communications network, wherein i) the pre-defined event is related to a change in a selection associated with a set of transmission reception points, TRPs, ii) the selection is performed by the UE based on measurements of one or more reference signals, and iii) the report information relates to the change in the selection associated with the set of TRPs.

In some examples, the pre-defined event may comprise a change in a selected set of TRPs. In such examples, the pre-defined event may, for instance, comprise a change in the selected set in which at least a threshold number of TRPs in the selected set have changed.

In some examples, the pre-defined event may comprise a change in the number of TRPs selected by the UE. In such examples, the pre-defined event may, for instance, comprise a change in the number of TRPs selected by the UE that is greater than a threshold number.

In some examples, the pre-defined event may comprise a change in at least one of: a selected non-coherent joint transmission, NCJT, measurement hypothesis; a selected single first-TRP measurement hypothesis; a selected single second-TRP measurement hypothesis; and a single TRP measurement hypothesis selected from a first-TRP measurement hypothesis and a second-TRP measurement hypothesis.

In some examples, the pre-defined event may comprise a change in a selection of at least one CSI reference signal, CSI-RS, resource or at least one CSI-RS resource pair.

In some examples the report information may indicate that the pre-defined event has occurred. The report information may include channel state information relating to the change in the selection associated with the set of TRPs.

The predefined event may, in some examples, comprise a change in a selection associated with at least one TRP that persists for a pre-determined duration or over a predetermined number of iterations.

The UE (or terminal device) may further comprise means for, while operating in the event-triggered CSI reporting mode, responding to an occurrence of any of a plurality of pre-defined events relating to a change in a selection associated with a set of TRPs by providing report information to the cellular communications network.

In some examples, the UE (or terminal device) may further comprise, while operating in the event-triggered CSI reporting mode in accordance with the configuration information, means for responding to a determination that the pre-defined event has not occurred by providing to the cellular communications network information indicative of the pre-defined event not having occurred. In such examples, the UE (or terminal device) may comprise means for responding to a determination that the pre-defined event has not occurred for a predetermined duration by providing the information indicative of the pre-defined event not having occurred to the cellular communications network.

In some examples, the predefined event may be indicated in the configuration information, and/or one or more parameters associated with the predefined event may be indicated in the configuration information.

In some examples, the UE (or terminal device) may further comprise means for, prior to receiving the configuration information, informing the cellular communications network that the pre-defined event is supported by the UE.

In some examples, the selection associated with the set of TRPs may be performed by the UE based on measurements of one or more reference signals and based on one or more threshold values configured by the cellular communications network.

In a third aspect, this specification describes a method comprising: providing, by a node of a cellular communications network and to a user equipment, UE, configuration information relating to an event-triggered CSI reporting mode in which the UE is configured to report to the cellular communications network in response to the UE detecting an occurrence of an event relating to a change in a selection, by the UE, that is associated with a set of transmission reception points, TRP; and receiving, by the node and from the UE, report information relating to detection, by the UE, of an occurrence of a predefined event that relates to a change in the selection associated with the set of TRPs. In some examples, the method may comprise, in response to the report information, at least one of performing responsive actions and providing responsive indications or instructions to the UE.

In a fourth aspect, this specification describes a cellular communications network node comprising: means for providing to a user equipment, UE, configuration information relating to an event-triggered CSI reporting mode in which the UE is configured to report to the cellular communications network in response to the UE detecting an occurrence of an event relating to a change in a selection, by the UE, that is associated with a set of transmission reception points, TRP; and means for receiving, from the UE, report information relating to detection, by the UE, of an occurrence of a predefined event that relates to a change in the selection associated with the set of TRPs. In some examples, cellular communications network node may comprise means for, in response to the report information, at least one of performing responsive actions and providing responsive indications or instructions to the UE.

In a fifth aspect, this specification describes apparatus (e.g. a UE or terminal device or a component of a UE or terminal device) comprising at least one processor and at least one memory storing instructions that, when executed by the at least one processor, cause the apparatus at least to: receive, at a user equipment, UE, and from a node of a cellular communications network, configuration information relating to an event-triggered channel state information, CSI, reporting mode; and, while operating in the event-triggered CSI reporting mode in accordance with the configuration information, respond to an occurrence of a pre-defined event by providing report information to the cellular communications network, wherein i) the pre-defined event is related to a change in a selection associated with a set of transmission reception points, TRPs, ii) the selection is performed by the UE based on measurements of one or more reference signals, and iii) the report information relates to the change in the selection associated with the set of TRPs.

In some examples, the pre-defined event may comprise a change in a selected set of TRPs. In such examples, the pre-defined event may, for instance, comprise a change in the selected set in which at least a threshold number of TRPs in the selected set have changed.

In some examples, the pre-defined event may comprise a change in the number of TRPs selected by the UE. In such examples, the pre-defined event may, for instance, comprise a change in the number of TRPs selected by the UE that is greater than a threshold number.

In some examples, the pre-defined event may comprise a change in at least one of: a selected non-coherent joint transmission, NCJT, measurement hypothesis; a selected single first-TRP measurement hypothesis; a selected single second-TRP measurement hypothesis; and a single TRP measurement hypothesis selected from a first-TRP measurement hypothesis and a second-TRP measurement hypothesis.

In some examples, the pre-defined event may comprise a change in a selection of at least one CSI reference signal, CSI-RS, resource or at least one CSI-RS resource pair.

In some examples the report information may indicate that the pre-defined event has occurred. The report information may include channel state information relating to the change in the selection associated with the set of TRPs.

The predefined event may, in some examples, comprise a change in a selection associated with at least one TRP that persists for a pre-determined duration or over a predetermined number of iterations.

In some examples, the instructions may, when executed by the at least one processor, cause the apparatus to, while operating in the event-triggered CSI reporting mode, respond to an occurrence of any of a plurality of pre-defined events relating to a change in a selection associated with a set of TRPs by providing report information to the cellular communications network.

In some examples, the instructions may, when executed by the at least one processor, cause the apparatus to, while operating in the event-triggered CSI reporting mode in accordance with the configuration information, respond to a determination that the pre-defined event has not occurred by providing to the cellular communications network information indicative of the pre-defined event not having occurred. In such examples, the instructions may, when executed by the at least one processor, cause the apparatus to respond to a determination that the pre-defined event has not occurred for a predetermined duration by providing the information indicative of the pre-defined event not having occurred to the cellular communications network.

In some examples, the predefined event may be indicated in the configuration information, and/or one or more parameters associated with the predefined event may be indicated in the configuration information.

In some examples, the instructions may, when executed by the at least one processor, cause the apparatus to, prior to receiving the configuration information, inform the cellular communications network that the pre-defined event is supported by the UE.

In some examples, the selection associated with the set of TRPs may be performed by the UE based on measurements of one or more reference signals and based on one or more threshold values configured by the cellular communications network.

In a sixth aspect, this specification describes apparatus (e.g. a node of a cellular communications network or a component of such a node) comprising at least one processor and at least one memory storing instructions that, when executed by the at least one processor, cause the apparatus at least to: provide to a user equipment, UE, configuration information relating to an event-triggered CSI reporting mode in which the UE is configured to report to a cellular communications network in response to the UE detecting an occurrence of an event relating to a change in a selection, by the UE, that is associated with a set of transmission reception points, TRP; and receive, from the UE, report information relating to detection, by the UE, of an occurrence of a predefined event that relates to a change in the selection associated with the set of TRPs

In a seventh aspect, this specification describes a non-transitory computer readable medium comprising program instructions stored thereon for causing performance of any of the operations described with reference to any of the first to sixth aspects.

### BRIEF DESCRIPTION OF THE FIGURES

Non-limiting examples will now be described with reference to the accompanying drawings, in which:

FIG. 1 is a schematic illustration of an example a cellular communications network;

FIG. 2 is a flow chart which illustrates various operations that may be performed by a user equipment (UE) within a cellular communications network;

FIG. 3 is a flow chart which illustrates various operations that may be performed by a network node (e.g. a gNB) within a cellular communications network;

FIG. 4 is a schematic illustration of an example configuration of a UE;

FIG. 5 is a schematic illustration of an example configuration of a network node; and

FIG. 6 is an illustration of an example computer-readable medium.

### DETAILED DESCRIPTION

The technology described herein relates to an event-triggered CSI reporting mode for a UE within a cellular communications network, such a New Radio cellular communications network (NR).

Existing CSI reporting modes in NR cellular communications networks include periodic, aperiodic, and semi-persistent CSI reporting modes. For periodic CSI reporting, the UE may be configured to send CSI reports in response to periodically transmitted CSI reference signals. For aperiodic and semi-persistent CSI reporting, the base station (BS) may send the UE a CSI report trigger, which indicates that the UE should send a CSI report, or, for semi persistent reporting, begin sending periodic CSI reports, based on one or more CSI reference signals. As set out in the Background, CSI reports may include one or more of Channel Quality Indicator (CQI), precoding matrix indicator (PMI), CSI-RS resource indicator (CRI), SS/PBCH Block Resource indicator (SSBRI), layer indicator (LI), rank indicator (RI) and/or L1-RSRP.

In order to get a full and accurate picture of the UE conditions and to optimize, for instance, beam switching, CSI reporting in the periodic and semi-persistent modes may require a high periodicity (i.e. short intervals between reports). However, the cost of CSI reporting with such a high periodicity is the resources consumed by such reports, which translates into less data scheduling opportunities, and so reduced maximum achievable UE throughput. In addition, although aperiodic CSI reporting may not have such a high overhead, it may be difficult for the network to maintain such an accurate and up-to-date picture of channel conditions as may be possible with aperiodic and semi-persistent CSI reporting. In addition, aperiodic CSI reporting may be associated with a higher DL overhead due to the need for repeated report triggers.

In the event-triggered CSI reporting mode described herein, the UE may be triggered to send reports responsive to detecting one or more events relating to multiple transmission reception point (multi-TRP) operation. This may obviate or reduce the need for the network to send CSI trigger messages in order to trigger the sending of a report, and the UE may not be configured by the network to send reports on a periodic or semi-periodic basis. Instead, the UE may send a report responsive to the UE detecting an occurrence of a particular pre-defined event which relates to a selection, by the UE and based on measurements of one or more reference signals, that is associated with a set of transmission-reception points.

As explained in more detail below, in some examples, the predefined event may correspond to a determination by the UE that it would be preferable to switch from receiving joint transmissions (from multiple TRPs) to receiving transmission from single TRPs (or vice versa) or to change the number or set of TRPs from which joint transmissions are received. Such determinations (and indeed those related to other example pre-defined events described herein) may be made when the channel conditions are determined to have changed. As such, in effect, the change in channel conditions experienced by the UE may, in some examples, indirectly trigger the UE to report to the network. Such changes in channel conditions may, for instance, result from a change in the multipath environment, a UE antenna/panel being covered by user, or the UE being moved or rotated. However, it will also be appreciated that the UE may also or instead base its determination/selection on other factors. These may include, but are not limited to, UE power requirements such as a need or preference for turning on or off antennas/panels of the operating frequency range (e.g., FR1 or FR2-1 or FR2-2 or a combination of them).

As will be appreciated, the event-triggered CSI reporting mode may be associated with certain advantages such as one or more of improved network energy efficiency, reduced reporting overhead, reduced latency and increased data scheduling opportunities.

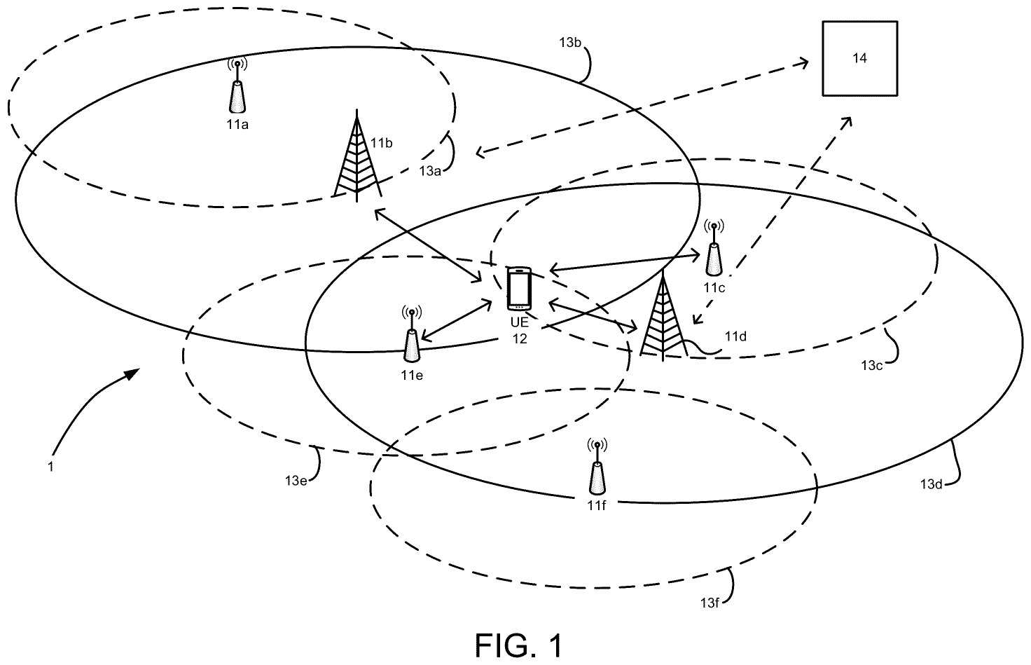

FIG. 1 illustrates an example cellular communications network 1 in which aspects of the present disclosure may be performed. For example, the cellular communications network 1 may be a New Radio (NR) or 5G network. The cellular communications network 1 may comprise multiple nodes or base stations (BS) 11a-11f (generally referred to with the numeral 11). In a 5G network, these nodes or base stations may be referred to as Node Bs or next generation Node Bs (gNBs). Each BS 11 may provide communication coverage for a particular geographic area 13a-13f. In 3GPP, the term “cell” can refer to a coverage area of a gNB and/or a gNB subsystem serving this coverage area, depending on the context in which the term is used. In NR systems, the term “cell” and next generation NodeB (gNB or gNodeB), NR BS, 5G NB, access point (AP), or transmission reception point (TRP) may be interchangeable.

A network controller 14 may couple to a set of BSs and provide coordination and control for these BSs. For simplicity, FIG. 1 shows the network controller 14 in communication with only two of the BSs 11b and 11d. However, it will be appreciated that the controller may additionally be in communication with a different number or selection of the BSs. The network controller 14 may communicate with the BSs 11 via a backhaul. The BSs 11 may also communicate with one another (e.g., directly or indirectly) via wireless or wireline backhaul.

One or more UEs 12 may be located within the cellular communications network, and each UE 12 may be stationary or mobile. Each UE 12 may be connected to the network via a particular BS 11. Further, in the case of multi-TRP operation”, a given UE 12 may be connected to the network via multiple BSs or TRPs. In FIG. 1, and as an example only, the UE 12 is shown to be in communication with four different BSs 11b-e. To enable this, a BS 11 in the cellular communications communication network 1 may configure a UE 12 with a channel state information (CSI) report configuration. This CSI report configuration may configure CSI reference signal (CSI-RS) resources from more than one BS. The UE 12 may perform measurements based on the configured CSI-RS resources and select preferred resources. Depending on the measurements, the UE 12 may select preferred resources associated with multiple TRPs (or BSs) or associated with a single TRP (or BS). For instance, where the measurements indicate a stable channel, the UE 12 may select preferred resources associated with a single TRP (which may be referred to as the selected TRP). Alternatively, in a more dynamic channel, the UE 12 may select preferred resources associated with multiple different TRPs. In this case, each of the multiple different TRPs may be considered a selected TRP.

In this specification, when it is described that the UE may transmit/provide information “to the network” or may receive information “from the network”, it will be appreciated that the information may transmitted to or received from any suitable network node. For instance, information may be transmitted to a radio access node such as a gNB, and may then be forwarded to a different entity/function. Similarly, information received from a network may be received from a given entity/function via a radio access node such as a gNB. Alternatively, depending on the nature of the information, it may be received from or transmitted to the gNB.

3GPP Release 17 defines a multi-TRP transmission mode referred to as non-coherent joint transmission (NCJT) and Release 18 defines another multi-TRP transmission mode known as coherent joint transmission (CJT). Non-coherent joint transmission is a technique that allows multiple TRPs to send a common message or different layers/parts of a message to a given UE 12 without aligning their phases at the UE. Coherent joint transmission on the other hand allows multiple TRPs to send a common message with phase constructively combined at a receiver.

Release 17 includes improvements to non-coherent joint transmission (NCJT). Specifically, it supports joint channel measurements at the UE 12 by configuring a channel measurement resource (CMR) pair within the same CSI-RS resource set corresponding to two TRPs respectively. Therefore, a CSI-RS resource set is divided as two CMR groups so that each CMR pair consists of one CMR from Group 1 and one CMR from Group 2. Release 17 defines a CSI report configuration which configures the UE 12 one or two (N=1,2) NCJT measurements and M≥0 single-TRP measurements. The UE 12 may then determine or select, based on the measurements, the best NCJT measurement hypothesis. Similarly, the UE 12 may determine or select, based on measurements, a best measurement hypothesis for each of one or more single TRPs. In a first reporting mode (Mode 1), the UE 12 includes X+1 CSIs in a single report. These are the “best” NCJT CSI, and the X “best” single-TRP CSIs, where X∈{0,1,2} and is configured by the network. If X=1, the single-TRP CSI is the best between the two TRPs. In a second reporting mode (Mode 2), the UE 12 is configured to report the single CSI, which is the best out of NCJT CSI and single-TRP CSIs.

As will be appreciated, measurement hypotheses relating to CSI may be determined using a wide variety of estimation methods, which would be apparent to the skilled person. In general terms, CSI estimation may relate to the problem of estimating channel properties of a communications link (e.g. between a UE and a BS). As described in greater detail below, measurements of signals (e.g. reference signals, RS) transmitted via the communication link may be used to determine such estimates. A CSI estimate may be referred to as a ‘hypothesis’.

The “best” or “preferable” one of two or more CSI hypotheses may be based on UE implementation and/or based on measuring some CSI quantity (such as CQI, rank, etc.) and comparing it for the different hypotheses. For example, the best/preferable between two or more CSI hypotheses may correspond to the one which results in higher CQI. The above definition of best/preferable may also be valid for a TRP selection (hypothesis), i.e., which TRP set is preferable/best. In this case, the resulting TRP set based on current measurements may be compared (e.g., from CQI perspective) with the previously selected TRP set which was measured and/or reported.

In some examples, the “best” hypothesis, TRP, TRP-pair or, more generally, “link” may be that associated with one or any combination of the highest RSRP, the highest SINR, the highest rank or the highest throughput. In some examples, a “best” TRP pair may correspond to the pair of links that together are associated with the highest RSRP. In other examples, the “best” TRP pair may correspond to the pair of links with the highest rank.

In some non-limiting examples, CSI may describe propagation characteristics of signals transmitted via the communications link, which may be reflected, refracted, and/or scattered by the environment, and attenuate with distance travelled. For instance, in some non-limiting examples, propagation of signals via a communications channel may be modelled using a linear system y=Hx+n, where y is the receive vector (i.e. the signal after propagation via the channel) and x is the transmit vector (i.e. the signal as transmitted), n is a noise vector (which may be modelled as a multivariate normal distribution), and H is the ‘channel matrix’. CSI estimation may therefore relate to determination of an estimate for the channel matrix H. As will be appreciated, in such examples, the components of y may correspond to one or more receive antennas and the components of x may correspond to one or more transmit antennas used for propagating the signal via the channel. Further, the coefficients of H may correspond to gain(s) and/or delay(s) associated with the channel. Various statistical methods may be used for determining an estimate for the channel matrix. For instance, a channel estimate may be determined using at least one of: least squares estimation, minimum mean square estimation, maximum likelihood estimation or neural network-based approaches, though other techniques would be apparent to the skilled person.

As will be appreciated, the NCJT and single-TRP measurement hypotheses may change as the channel conditions change. For instance, at a first time when the channel conditions are dynamic, the UE 12 may determine that an NCJT measurement hypothesis may be better than (or is preferred over) either of the single-TRP measurement hypotheses. Then, at a second time e.g. when the channel conditions are more stable, the UE 12 may determine that one of the single-TRP measurement hypotheses is better than (or is preferred over) the NCJT measurement hypothesis. The NJCT measurement hypothesis is associated with multiple TRPs and, in some examples described herein, when the best NJCT measurement hypothesis is determined to be better than the single-TRP measurement hypotheses (e.g. estimated to yield a higher throughput), those multiple TRPs may be considered to be selected or preferred TRPs. Conversely, when a particular single-TRP measurement hypothesis is determined to be the best (e.g. better than any NCJT measurement hypothesis) that single TRP may be considered to be the selected or preferred TRP.

Release 18 defines enhancements for CJT. It specifies that the UE 12 can be configured with N_{TRP}∈{1,2,3,4} CSI-RS resources in a resource set for channel measurement. Put another way, the UE 12 may be configured by the network to perform measurements based on reference signals from N_{TRP} different TRPs, where N can take any value between 1 and 4. Based on the measurements, the UE 12 may select N CSI-RS resources, each associated with a respective TRP, where 1≤N≤N_{TRP}. The selection may be reported via an N_{TRP}-bit bitmap. In such a bitmap, a “1” may be used to indicate a selected TRP and a “0” may be used to indicate a TRP that has not been selected, or vice versa. The manner or basis on which the TRPs are selected or deemed preferred may be dependent on the specific UE 12 implementation.

The techniques described herein relating to an event-triggered CSI reporting mode in which a UE 12 is triggered to send report information in response to an occurrence of a pre-defined event related to a change in a selection associated with a set of TRPs. The set of TRPs may be one or more of a plurality of TRPs that are associated with CSI-RS resources that are currently configured for the UE. As described above, the selection may be performed by the UE 12 based on measurements of those CSI-RS resources. However, the precise manner of selection may depend on the particular UE implementation. It may, for instance, be based on one or any combination of: UE RSRP/SINR measurements, UE power consumption requirements (for instance, the need to turn off antennas/panels to save power or whether there is enough power to turn on additional antennas/panels), user presence (e.g. a user covering an antenna/panel), UE movement/rotation, channel dynamicity, and operating frequency range (e.g., FR1 or FR2-1 or FR2-2 or a combination of them).

A change in a selection associated with the set of TRPs may occur when a particular selection has changed since the UE 12 previously made the selection and/or reported the selection to the network. The report information may indicate to the network that the pre-defined event has occurred and/or may include an indication of the new selection that triggered the report. For instance, the report may include channel state information relating to the change in the selection associated with the set of TRPs. In examples in which channel state information is not included in the report information, the network may respond to the report by instructing the UE to provide a CSI report.

### Example Pre-Defined Events

Various non-limiting examples of pre-defined events related to a change in a selection associated with a set of TRPs, which may trigger the UE 12 to send report information, are discussed below. However, it will be appreciated that other examples are also possible. For instance, although some of the examples described herein refer to “selected TRPs” or “selected set of TRPs”, in other implementations, the term TRP may correspond to (or be replaced by) one or more of: TRP ID, CORESETPoolIndex, PCI (physical cell identity), SRS (sounding reference signal) resource set, reference signal (such as CSI-RS or SSB) set, reference signal resource or resource set, RRH (remote radio head), etc. It will be appreciated that each of these may be “selected” by the UE based on measurements of reference signals, and that one or more of the pre-defined events utilised by the UE and discussed below may be defined in terms of, for instance, selected TRP ID, selected PCI, selected RRH, etc. rather than selected TRP as per the below discussion.

In a first example, the pre-defined event comprises a change in a selected set of one or more TRPs. Put another way, the pre-defined event may be that the UE 12 has currently selected a set of TRPs that is different from a set of TRPs that the UE 12 previously selected and/or reported. For instance, in a NCJT context of Release 17, if the UE 12 previously selected or preferred a TRP pair (e.g. that associated with a “best” NCJT measurement hypothesis), but now selects or prefers a different TRP pair or a single TRP, this may be considered a change in a selected set of TRPs, and may trigger the UE 12 to send report information. Likewise, if the UE 12 previously selected a single TRP but now selects a different single TRP or a TRP pair for NCJT, this may be considered a change in a selected set of TRPs. Similarly, in the CJT context of Release 18, if the UE 12 previously selected a first TRP and now selects a second TRP, or previously selected a first TRP and a second TRP and now selects the second TRP only or the second TRP and a third TRP, this may be considered a change in the selected set of TRPs.

In some implementations of the first example, the pre-defined event may comprise a change in the selected set in which at least a threshold number of TRPs in the selected set have changed. For instance, the threshold may be two, in which case a change in selection from a first TRP and a second TRP to just the second TRP may not constitute an occurrence of the pre-defined event (because only one TRP has changed). However, a change in selection from a first TRP and a second TRP to a third TRP and a fourth TRP, or a change in selection from a first TRP to the first TRP, the second TRP and the third TRP, would constitute an occurrence of the pre-defined event. The threshold may be configured by the network, or may be reported by the UE 12 e.g., in capabilities, in UE 12 Assistance or in MAC CE (Medium Access Control, MAC, Control Element). The value of the threshold may dictate an extent of change of the channel conditions that is required to trigger the sending of a report. For instance, a low threshold, e.g. 1, results in report information being sent when the selected set has changed only a little, which may correspond to a small change in the channel conditions, whereas a higher threshold may result reports not being sent for such small changes in channel conditions. Thus, the network may use the threshold to increase or decrease the number of reports that are sent by a given UE.

In a second example, the pre-defined event may comprise a change in the number of TRPs selected by the UE. In other words, the number of TRPs that the UE 12 previously selected and/or reported is different from the current number of TRPs the UE 12 has selected. For example, in a stable channel, the UE 12 may have chosen only N TRPs (e.g., where N=1) then, when the channel is determined to have become significantly more dynamic, the UE 12 may increase the number of selected TRPs (e.g., to 2 or 4). This may allow the UE 12 to make use of CJT or NCJT, and so maintain the reliability of the link and avoid failures or resource costly handovers.

In some implementations of the second example, a threshold change may be employed. Put another way, the pre-defined event may comprise a change in the number of TRPs selected by the UE 12 that is greater than a threshold number. For instance, if the threshold were set to two, a change from one selected TRP to two selected TRPs would not be sufficient to trigger the sending of report information, but a change from one selected TRP to four selected TRPs would trigger the sending of report information. Similarly, to the first example, the threshold may be configured by the network. It may be used, for instance, to affect the number of event-triggered reports that are sent by UEs connected to the network.

In a third example, the pre-defined event may comprise a change in at least one of: i) selected joint transmission measurement hypothesis (e.g. a best NCJT measurement hypothesis); ii) a selected (e.g. best) measurement hypothesis for a first TRP; iii) a selected (e.g. best) measurement hypothesis for a second TRP; and iii) a selected (e.g. best) single-TRP measurement hypothesis. The selected single-TRP hypothesis may, for instance, be the best measurement hypothesis of the best measurement hypothesis for the first TRP and the best measurement hypothesis for a second TRP. As will be appreciated, in examples in which there are more than two TRPs, the pre-defined event may additionally or alternatively comprise a change in, for instance, a selected (e.g. best) measurement hypothesis for a third or fourth TRP. Similarly, in such a context, the selected single-TRP hypothesis may, for instance, be the best measurement hypothesis of the best measurement hypothesis for the first, second, third and possibly even fourth single-TRP measurement hypotheses. In some examples, the selected or best single-TRP hypotheses may not necessarily be those individually associated with the highest RSRP. Instead, the best single TRPs may be the TRPs associated with links that have a similar RSRP and so yield the highest rank.

In the third example, the UE may be triggered to provide a report in response to determining that the selected (e.g. “best”) joint transmission measurement hypothesis has changed. In addition, or alternatively, a change in one or more of the single-TRP measurement hypotheses may also trigger the UE to provide a report. As with the first and second examples, a change in these measurement hypotheses may be an indication of a change in channel conditions, and so the UE may, in effect, be reporting to the network when it has experienced a change in channel conditions.

In a fourth example, the pre-defined event may comprise a change in a selection, by the UE 12 and based on measurements of reference signals, of at least one CSI reference signal (CSI-RS) resource or at least one CSI-RS resource pair. It will of course be appreciated that a CSI-RS resource pair may correspond to two TRPs and a CSI-RS resource may correspond to one TRP. For example, the UE determines that a previously selected at least one CSI-RS resource is different from the current selected at least one CSI-RS resource, the UE may be triggered to send a report. Similarly, if the UE 12 has previously selected a CSI-RS resource pair and the UE 12 has currently selected a CSI-RS resource (instead of the resource pair), or the UE 12 has previously selected a CSI-RS resource and the UE 12 has currently selected a CSI-RS resource pair, the UE may be triggered to send a report. Again, such changes in selection may be reflective of a change in channel conditions.

In some examples, the UE 12 may be configured to respond to a particular one of the example pre-defined events described herein. However, in other examples, the UE may be configured to respond to an occurrence of any one of a plurality of different pre-defined events. For instance, and by way of example only, the UE may be configured to respond when either 1) there is a change in the selected set in which at least a threshold number of TRPs in the selected set have changed (as described in the first example), or 2) there is a change in the number of TRPs selected by the UE (as described in the second example). If more than one of the plural pre-defined events is determined to have occurred, the report information may indicate this.

In some implementations, the UE 12 may indicate to the network which of the plurality of different pre-defined events the UE supports for event-triggered reporting. This may be indicated in UE capability information.

In some examples, the selection associated with the set of TRPs is performed by the UE based on measurements of one or more reference signals and based on one or more metric(s) or criteria (e.g. threshold values) configured by the cellular communications network. For instance, the TRPs, the number of TRPs, the set of TRPs selected and/or reported by UE 12 may depend on some metric(s) or criteria configured by the network such as, but not limited to minimum CQI, minimum rank, RSRP threshold, SINR threshold, etc. In such examples, the selection of the set of TRP may at least consider whether or not the selected TRPs result in the configured criteria/criterium being satisfied.

### Example Methods

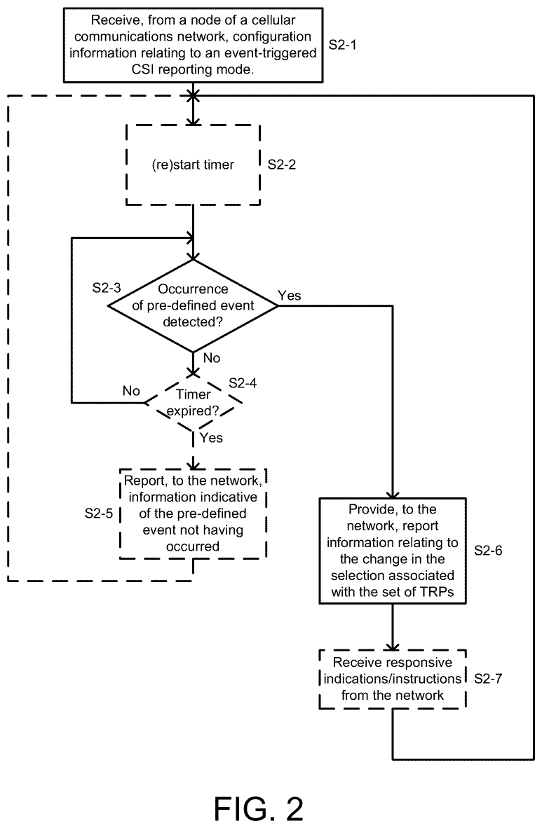

FIG. 2 illustrates a flow chart depicting example operations which may be performed by a UE 12 in accordance with various examples described herein. In FIG. 2, some of the operations and connections are indicated with dashed lines, which indicate that various ones of those operations may be omitted or optional. For instance, in some examples, all operations shown with dashed lines may be omitted. In other examples, however, only some of the operations shown with dashed lines (e.g. operations S2-2, S2-4, and S2-5) may be omitted while others (e.g. S2-8) may be included, or vice versa.

In operation S2-1, a UE 12 receives from a network node (e.g. a gNB 12) of a cellular communications network, configuration information relating to an event-triggered CSI reporting mode. This configuration information may, for instance be in the form of CSI reporting configuration or a CSI triggering state. The configuration information may indicate the pre-defined events in response to which the UE 12 should provide report information. In some examples, the configuration information may cause the UE 12 to begin operating in the event-triggered CSI reporting mode. In other examples, the configuration may change or adjust the events which trigger the UE 12 to provide report information. For instance, the configuration information may include parameters, such as those discussed herein, for adjusting the event-triggered CSI reporting mode. For instance, values of the timers/counters and/or thresholds described herein may be indicated in the configuration information.

After having received the configuration information, and while operating in the event-triggered CSI reporting mode, the UE 12 may, as described herein, perform selections associated with a set of TRPs. When doing so, the UE 12 may monitor for changes in selections associated with a set of TRPs. Put another way, the UE 12 may compare current selections associated with set of TRPs with previous selections, about which reports may have been sent to the network. In this way, in operation S2-3, the UE 12 can determine whether a pre-defined event that relates to a particular change in a selection associated with a set of TRPs has occurred. The pre-defined event may, for instance, be one or more those described above with reference to FIG. 1 and may have been indicated in or configured via the configuration information.

In response to determining that the pre-defined event has occurred, the UE, in operation S2-6 provides report information relating to the change in the selection associated with the set of TRPs. The report information may indicate to the network that the pre-defined event has occurred and/or may include channel state information relating to the change in the selection associated with the set of TRPs. The report may, for instance indicated the new selections, which triggered the provision of the report. For instance, in some specific examples, the report information may indicate a bitmap representing the “newly” selected set of TRPs, and/or may report other CSI quantities related to this “new” selection. The report information may, for instance, be sent to the node (e.g. a gNB) from which the configuration information was originally received.

In some, non-limiting, examples, the report information may be sent as UCI (uplink control information) or UL MAC CE, carried through a PUCCH (physical uplink control channel) or PUSCH (physical uplink shared channel). The PUCCH/PUSCH resources may be some dedicated or shared resources that could be used for such ‘reporting’. Those resources may be configured as periodic. Alternatively, the resources may be scheduled e.g., via DCI by the network for some other purposes (such as scheduling data transmission). In other words, the UE may have some valid UL grant, and UE may send the report information through the corresponding resources etc.

In some examples, the network (e.g. the gNB or some other entity/node) may utilize the information sent by the UE as basis for performing one or more of the responsive actions. For instance, based on reported information regarding changed selections, the network may mute or unmute TRP(s). For instance, a newly selected TRP may be unmuted and a newly unselected TRP may be muted. In addition, or alternatively, the network may determine based on the reported information to use a multi-TRP scheme or single-TRP operation.

In some examples, having provided the report information, the UE 12 may, in operation S2-7, receive responsive indications or instructions from the network, e.g. the gNB. For instance, the UE may receive confirmation of any actions taken by the network responsive to the report information or may receive instructions to reconfigure e.g. the resources it is using. As another example, the network may, based on the report information, trigger the UE to provide a CSI report.

Although not illustrated in FIG. 2, the UE 12 may then perform its own actions based on the responsive indications or instructions received from the network. For instance, it may provide a CSI report as instructed by the network. As another example, in response to an indication that TRPs have been or will be muted or unmuted, and/or that transmission has switched/will switch from multi- to single-TRP operation, or vice versa, the UE may adjust its operation accordingly. In yet other examples, the UE may, having sent the report information but without having received any signalling from the network, change its operation in accordance with its selections that triggered the provision of the report. Put another way, the UE may assume that the network will take the necessary actions in accordance with its selections, and so may proceed accordingly. These latter examples, in which the network may act without instructing a CSI report may be particularly efficient in terms of bandwidth and/or signalling.

After operation S2-6, or S2-7, the UE 12 may continue operating in the event-triggered CSI reporting mode. Accordingly it may perform selections associated with a set of TRPs and monitor for changes in selections that correspond to one or more pre-defined events. When an occurrence of a pre-defined event is selected, the UE responds by sending report information.

In some examples, the pre-defined event may not simply require a change in a selection associated with the set of TRPs but may additionally require that change to persist for a predetermined duration or number of iterations of performing such selections. For instance, the UE 12 may not consider an event to have occurred if a given selection iteration yields a particular change in selection, but in a subsequent selection iteration (or a selection that is within a particular duration from the given selection iteration), the selection reverts back to the original selection. However, if the change persists for a predetermined duration or number of iterations, the pre-defined event may be considered to have occurred.

In some examples, the UE may be configured, while operating in the event-triggered CSI reporting mode in accordance with the configuration information, to respond to a determination that the pre-defined event has not occurred (for instance, for a predetermined duration) by providing to the cellular communications network information indicative of the pre-defined event not having occurred. For instance, as illustrated in FIG. 2, in some examples, the UE 12 may, in operation S2-2, start a timer following receipt of the configuration information in operation S2-1. In other examples, the timer may be started by the UE the first time the UE makes a selection in which there is no change from the previous selection. In other words, the timer may be started in response to a determination of a first unchanged selection. The timer may have a duration that may be configured by the network or set by the UE. The timer may be used by the UE 12 to determine when it should report back to the network if an occurrence of the pre-defined event has not been detected. This may occur, for instance, when the channel conditions are very stable. As such, in operation S2-4, the UE, may determine whether the timer started in operation S2-2 has expired without an occurrence of a predefined having been detected. Although, in FIG. 2, operation S2-4 is shown following a negative determination in operation S2-3, this is for illustrative purposes only.

In response to determining that the timer has expired without an occurrence of a predefined event having been detected, the UE 12 may report back to the network. The report may be indicative of the pre-defined event not having occurred. For instance, it may be indicative of there having been no change in the selected TRP set. The sending of this report may allow the network to determine that the uplink channel between UE 12 and the network is still working. After having reported back to the network, the UE 12 may return to operation S2-2 and restart the timer. It may then continue operating in the event-triggered CSI reporting mode. As will of course be appreciated, the use of a timer is an example only and the UE 12 may use a counter (e.g. a number of selection iterations) or some other mechanism for ensuring that it reports back to the network from time to time.

If, before the timer has expired, an occurrence of a pre-defined event is detected, the timer may be restarted. Restarting of the timer may be triggered, for instance, by detection of the occurrence of the pre-defined event, by the provision of the report to the network (in S2-6), or by the next selection in which there is no change from the previous selection.

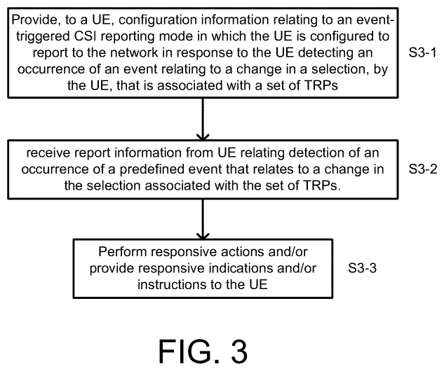

FIG. 3 is a flow chart depicting example operations which may be performed by a network node of a telecommunications network, such as a gNB, according to examples of the techniques described herein.

In operation S3-1, the network node 11 may provide to a UE 12, configuration information relating to an event-triggered CSI reporting mode in which the UE 12 is configured to report to the network in response to the UE 12 detecting an occurrence of an event relating to a change in a selection, by the UE, associated with a set of TRPs. This configuration information may be as described with reference to the previous figures, not least operation S2-1 of FIG. 2.

In operation S3-2, the network node 11 receives from the UE 12 report information relating to a change in the selection associated with the set of TRPs. This report information may be as described elsewhere in the specification, not least with reference to operation S2-6 of FIG. 2. As explained above, in some examples, the reporting information may be sent by the UE as UCI or MAC CE. In such examples, the resources for the UCI or MAC CE may be configured as periodic resources (that is, available occasions in which to send the report information, with or without the related CSI). Alternatively, or additionally, UE may be able to send it through available UL resources used for other purposes. For instance, if there is a valid UL grant at the UE (used for transmitting data in UL), the UE may use the corresponding UL resources to carry the report information (such as through a MAC CE sent on PUSCH).

In operation S3-3, the network node 11 may provide responsive indications/instructions to the UE 12. This may, for instance, be as described with reference to operations S2-6 and S2-7 of FIG. 2 (or elsewhere in the specification). In addition or alternatively, and as also described, for instance, with reference to FIG. 2, the network may perform one or more actions or in response to the report information, e.g. based on the new selections that may be indicated in the report information.

### Example Configurations of Apparatuses

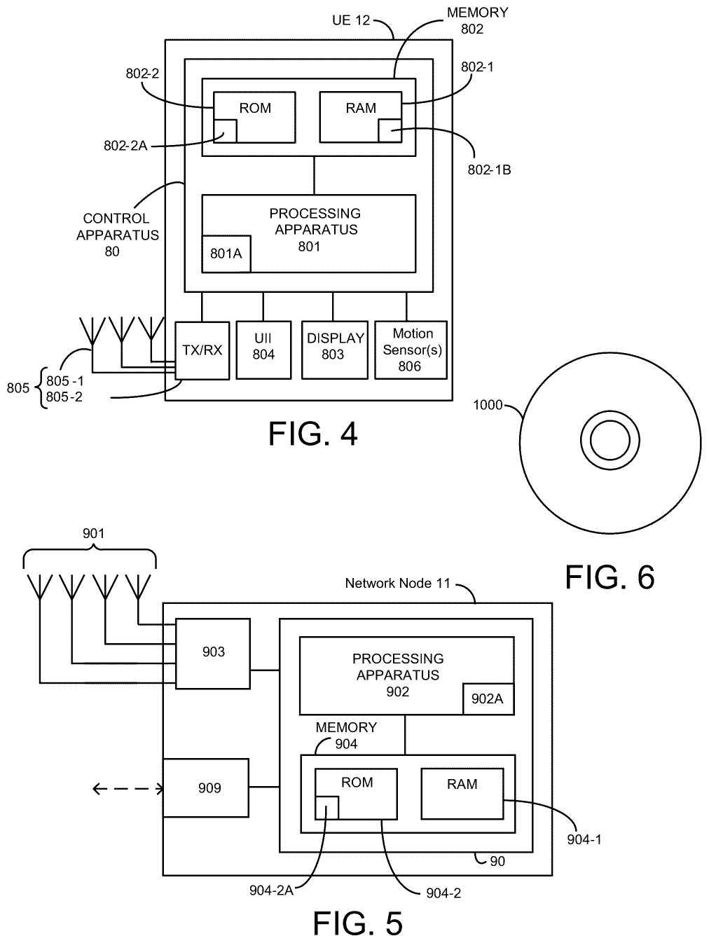

FIG. 4 is a schematic illustration of an example configuration of a UE 12 which may be configured to perform various operations described with reference to FIGS. 1 to 3.

The UE 12 may communicate, e.g. with a base station, via an appropriate radio interface arrangement 805. The interface arrangement 805 may be provided for example by means of a radio part 805-2 (e.g. a transceiver) and an associated antenna arrangement 805-1. The antenna arrangement 805-1 may be arranged internally or externally to the UE 12. In order to be able to utilise beam forming, the antenna arrangement 805-1 may includes multiple antennas. For instance, some UE's may include twelve antenna elements, e.g. four panels each having four cross-polarized antenna elements.

The UE 12 comprises a controller/control (or processing) apparatus 80 which is operable to control the other components of the terminal device UE in addition to performing any suitable combinations of the operations described in connection with UE 12 with reference to the preceding FIGS. The control apparatus 80 may comprise processing apparatus 801 and memory 802. Computer-readable code 802-2A may be stored on the memory 802, which when executed by the processing apparatus 801, causes the control apparatus 80 to perform any of the operations described herein in relation to the UE 12.

Example configurations of the memory 802 and processing apparatus 801 will be discussed in more detail below.

The UE 12 may be, for example, a device that does not need human interaction, such as an entity that is involved in Machine Type Communications (MTC). Alternatively, the UE 12 may be a device designed for tasks involving human interaction such as making and receiving phone calls between users and streaming multimedia or providing other digital content to a user. Non-limiting examples for the UE 12 include a smart phone, a laptop, a smartwatch, a tablet computer, an e-reader, a vehicle-based UE, such as those mounted on cars, buses, uncrewed aerial vehicles (UAVs), aeroplanes, trains, or boats, or any type of UE that may be carried by a user, or worn on their person.

Where the UE 12 is a device designed for human interaction, the user may control the operation of the UE 12 by means of a suitable user input interface UII 804 such as keypad, voice commands, touch sensitive screen or pad, combinations thereof or the like. A display 803, a speaker and a microphone may also be provided. Furthermore, the UE 12 may comprise appropriate connectors (either wired or wireless) to other devices and/or for connecting external accessories, for example hands-free equipment, thereto. The UE 12 may additionally be associated with (e.g., comprises or is in short range wired or wireless communication with) one or a plurality of motion sensors 806 for sensing motion of the mobile device. The UE may additionally include other sensors such as a GNSS unit.

FIG. 5 is a schematic illustration of an example configuration of a network node 11. As described above, the network node may be a radio access node, such as a gNB, or some other node in the network. In examples, in which the network node 11 is a radio access node, the node may be configured for communicating with the UE 12 via a wireless interface. In such examples, the network node 11 may, as depicted in FIG. 5, comprise a radio frequency antenna array 901 configured to receive and transmit radio frequency signals. Although the network node 11 is shown as having an array 901 of four antennas, this is illustrative only. The number of antennas may vary from two to many hundreds. The network node 11 further comprises radio frequency interface circuitry 903 configured to interface between the antenna 901 and a control apparatus 90. The radio frequency interface circuitry 903 may also be known as a transceiver.

The network node also comprises one or more interfaces 909 via which it can communicate (e.g. via X2 messages) with base stations and other network entities such as those of the core network. In examples, in which the network node is a node within the core network, the node 11 may not communicate directly with UE 12 and so may omit the RF components. However, the network node may utilise interface(s) 909 to communicate with other core network entities such as the AMF and the like.

The network node control apparatus 90 may be configured to cause the exchange of information with other network elements via the interface 909. In addition, in examples in which the network node is a RAN node, the network node control apparatus 90 may be configured to process signals from the radio frequency interface circuitry 903, control the radio frequency interface circuitry 903 to generate suitable RF signals to communicate information to the UE via the wireless communications link.

The network node control apparatus 90 may comprise processing apparatus 902 and memory 904. Computer-readable code 904-2A may be stored on the memory 904, which when executed by the processing apparatus 902, causes the control apparatus 90 to perform any of the operations assigned to the network node 11 described above.

As should of course be appreciated, the entities 11, 12 shown in each of FIGS. 4 and 5 described above may comprise further elements which are not directly involved with processes and operations in respect which this application is focused.

Some further details of components and features of the above-described apparatus/entities/apparatuses and alternatives for them will now be described.

The control apparatuses 80, 90 may comprise processing apparatus 801, 902 communicatively coupled with memory 802, 904. The memory 802, 904 has computer readable instructions 802-2A, 904-2A stored thereon, which when executed by the processing apparatus 801, 902 causes the control apparatus 80, 90 to cause performance of various ones of the operations described herein. The control apparatus 80, 90 may in some instances be referred to, in general terms, as “apparatus”.

The processing apparatus 801, 902 may be of any suitable composition and may include one or more processors 801A, 902A of any suitable type or suitable combination of types. For example, the processing apparatus 801, 902 may be a programmable processor that interprets computer program instructions 802-2A, 904-2A and processes data. The processing apparatus 801, 902 may include plural programmable processors. Alternatively, the processing apparatus 801, 902 may be, for example, programmable hardware with embedded firmware. The processing apparatus 801, 902 may be termed processing means. The processing apparatus 801, 902 may alternatively or additionally include one or more Application Specific Integrated Circuits (ASICs). In some instances, processing apparatus 801, 902 may be referred to as computing apparatus.

The processing apparatus 801, 902 is coupled to the memory (which may be referred to as one or more storage devices) 802, 904 and is operable to read/write data to/from the memory 802, 904. The memory 802, 904 may comprise a single memory unit or a plurality of memory units, upon which the computer readable instructions (or code) 802-2A, 904-2A is stored. For example, the memory 802, 904 may comprise both volatile memory 802-1 and non-volatile memory 802-2. For example, the computer readable instructions/program code 802-2A, 904-2A may be stored in the non-volatile memory 802-2, 904-2 and may be executed by the processing apparatus 801, 902 using the volatile memory 802-1, 904-1 for temporary storage of data or data and instructions. In some examples, a transmission buffer 802-1B of the terminal device 11 may be constituted by volatile memory 802-1 of the UE control apparatus 80. Examples of volatile memory include RAM, DRAM, and SDRAM etc. Examples of non-volatile memory include ROM, PROM, EEPROM, flash memory, optical storage, magnetic storage, etc. The memories in general may be referred to as non-transitory computer readable memory media.

The term ‘memory’, in addition to covering memory comprising both non-volatile memory and volatile memory, may also cover one or more volatile memories only, one or more non-volatile memories only, or one or more volatile memories and one or more non-volatile memories.

The computer readable instructions/program code 802-2A, 904-2A may be pre-programmed into the control apparatus 80, 90. Alternatively, the computer readable instructions 802-2A, 904-2A may arrive at the control apparatus 80, 90 via an electromagnetic carrier signal or may be copied from a physical entity 1000 such as a computer program product, a memory device or a record medium such as a CD-ROM or DVD an example of which is illustrated in FIG. 6. The computer readable instructions 802-2A, 904-2A may provide the logic and routines that enables the entities devices/apparatuses to perform the functionality described above. The combination of computer-readable instructions stored on memory (of any of the types described above) may be referred to as a computer program product.

Embodiments of the technology described herein may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing apparatus” etc. should be understood to encompass not only computers having differing architectures such as single/multi-processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

If desired, the different functions discussed herein may be performed in a different order and/or concurrently with each other. Furthermore, if desired, one or more of the above-described functions may be optional or may be combined. Similarly, it will also be appreciated that flow diagrams described herein are examples only and that various operations depicted therein may be omitted, reordered and or combined.

Although the methods and apparatuses have been described in connection with a New Radio (NR) network, it will be appreciated that they are not limited to such networks and are applicable to radio networks of various different types.

Although various aspects of the methods and apparatuses described herein are set out in the independent claims, other aspects may comprise other combinations of features from the described embodiments and/or the dependent claims with the features of the independent claims, and not solely the combinations explicitly set out in the claims.

It is also noted herein that while various examples are described above, these descriptions should not be viewed in a limiting sense. Rather, there are several variations and modifications which may be made without departing from the scope of the present invention as defined in the appended claims.

1. A method comprising:
receiving, at a user equipment (UE), and from a node of a cellular communications network, configuration information relating to an event-triggered channel state information (CSI), reporting mode; and
while operating in the event-triggered CSI reporting mode in accordance with the configuration information, responding, by the UE, to an occurrence of a pre-defined event by providing report information to the cellular communications network, wherein i) the pre-defined event is related to a change in a selection associated with a set of transmission reception points (TRPs), ii) the selection is performed by the UE based on measurements of one or more reference signals, and iii) the report information relates to the change in the selection associated with the set of TRPs.

2. A user equipment (UE), comprising:
at least one processor; and
at least one memory, the at least one memory storing instructions, that when
executed by the least one processor, to cause the UE to at least:
receive, from a node of a cellular communications network, configuration information relating to an event-triggered channel state information (CSI) reporting mode; and
respond, while operating in the event-triggered CSI reporting mode in accordance with the configuration information, to an occurrence of a pre-defined event by providing report information to the cellular communications network, wherein i) the pre-defined event is related to a change in a selection associated with a set of transmission reception points (TRPs) ii) the selection is performed by the UE based on measurements of one or more reference signals, and iii) the report information relates to the change in the selection associated with the set of TRPs.

3. The UE of claim 2, wherein the pre-defined event comprises a change in a selected set of TRPs.

4. The UE of claim 3, wherein the pre-defined event comprises a change in the selected set in which at least a threshold number of TRPs in the selected set have changed.

5. The UE of claim 2, wherein the pre-defined event comprises a change in the number of TRPs selected by the UE.

6. The UE of claim 5, wherein the pre-defined event comprises a change in the number of TRPs selected by the UE that is greater than a threshold number.

7. The UE of claim 2, wherein the pre-defined event comprises a change in at least one of:
a selected non-coherent joint transmission (NCJT) measurement hypothesis;
a selected single first-TRP measurement hypothesis;
a selected single second-TRP measurement hypothesis; and
a single TRP measurement hypothesis selected from a first-TRP measurement hypothesis and a second-TRP measurement hypothesis.

8. The UE of claim 2, wherein the pre-defined event comprises a change in a selection of at least one channel state information reference signal (CSI-RS), resource or at least one CSI-RS resource pair.

9. The UE of claim 2, wherein the report information indicates that the pre-defined event has occurred.

10. The UE of claim 2, wherein the report information includes channel state information relating to the change in the selection associated with the set of TRPs.

11. The UE of claim 2, wherein the predefined event comprises a change in a selection associated with at least one TRP that persists for a pre-determined duration or over a predetermined number of iterations.

12. The UE of claim 2, wherein the instructions, when executed by the at least one processor, while operating in the event-triggered CSI reporting mode, further cause the UE at least to:
respond to an occurrence of any of a plurality of pre-defined events relating to a change in a selection associated with a set of TRPs by providing report information to the cellular communications network.

13. The UE of claim 2, wherein the instructions, when executed by the at least one processor, while operating in the event-triggered CSI reporting mode, further cause the UE at least to:
respond, while operating in the event-triggered CSI reporting mode in accordance with the configuration information, to a determination that the pre-defined event has not occurred by providing to the cellular communications network, information indicative of the pre-defined event not having occurred.

14. The UE of claim 13, wherein the instructions, when executed by the at least one processor, while operating in the event-triggered CSI reporting mode, further cause the UE at least to:
respond, to the determination that the pre-defined event has not occurred for a predetermined duration by providing to the cellular communications network, information indicative of the pre-defined event not having occurred.

15. The UE of claim 2, wherein:
the pre-defined event is indicated in the configuration information, and/or one or more parameters associated with the predefined event are indicated in the configuration information.

16. The UE of claim 2, wherein the instructions, when executed by the at least one processor, further cause the UE at least to:
inform, prior to receiving the configuration information, the cellular communications network that the pre-defined event is supported by the UE.

17. The UE of claim 2, wherein the instructions, when executed by the at least one processor, further cause the UE at least to:
perform the selection associated with the set of TRPs, based on measurements of one or more reference signals and based on one or more threshold values configured by the cellular communications network.

18. A cellular communications network node comprising:
at least one processor; and
at least one memory, the at least one memory storing instructions, that when executed by the least one processor, to cause the cellular communications network node to at least:
provide to a user equipment (UE), configuration information relating to an event-triggered channel state information (CSI) reporting mode in which the UE is configured to report to the cellular communications network in response to the UE detecting an occurrence of an event relating to a change in a selection, that is associated with a set of transmission reception points (TRPs); and
receive, from the UE, report information relating to detection, by the UE, of an occurrence of a predefined event that relates to a change in the selection associated with the set of TRPs.
